(19) United States
(12) Patent Application Publication
(10) Pub. No.: US 2008/0156377 A1
(43) Pub. Date: Jul. 3, 2008

(54) Recovery system

(76) Inventor: Brad Mann, Raleigh, NC (US)

Correspondence Address: WILMERHALE/BOSTON, 60 STATE STREET, BOSTON, MA, 02109, US

(21) Appl. No.: 11/652,213

(22) Filed: Jan. 11, 2007

Related U.S. Application Data
(60) Provisional application No. 60/877,873, filed on Dec. 29, 2006.

(51) Int. Cl. B67D 5/06

(52) U.S. Cl. 137/263

(57) ABSTRACT

A system allows for the safe, rapid, efficient recovery of a drug solution from sealed vials. The system is closed so that highly potent compounds can later be recovered and reworked without large investment in further engineering controls.

### CROSS-REFERENCE TO RELATED APPLICATIONS

This application claims priority to U.S. Provisional Patent Application No. 60/877,873, filed Dec. 29, 2006 and entitled “Recovery System,” the entire contents of which are incorporated herein by reference.

### BACKGROUND

The invention generally relates to methods of recovering material from containers.

The products of the chemical, biotechnological, and pharmaceutical industries can be the result of immense investments of money, time, and effort. Occasionally a manufacturing or human error can create a problem. For example an unsafe contaminant could accidentally be introduced into the product, or a batch of the product could be accidentally packaged into non-sterile containers, where sterility of the product is required for safety. It may be desirable to recover as much of the product as possible, and then purify or sterilize it as appropriate.

### SUMMARY

In the embodiments described here, liquid can be recovered from stoppered vials by providing the vials upside down in a holding cassette over upwardly extending hollow needles. The needles puncture the stoppers in the vials and draw the liquid through a manifold to a vessel. The cassette with multiple vials can be manually provided in a holder and manually removed from the holder after the liquid is removed. The recovery process can be initiated with a safety feature that requires two simultaneous actions, such as two buttons to be pushed by two hands to prevent inadvertent actuation. The system preferably uses a peristaltic pump, which is preferably operated with a foot pedal actuation.

Other features and advantages will become apparent from the following detailed description, drawings, and claims.

### BRIEF DESCRIPTION OF THE DRAWINGS

FIG. 1 is a schematic diagram showing the components of a recovery system.

FIG. 2 is a detailed diagram of a vial holder and needle assembly.

FIG. 3 is a schematic diagram showing the components of an automated recovery system including a flip cap remover and conveyor belt.

FIG. 4 is a detailed diagram of a vial positioner.

FIGS. 5A and 5B show perspective views of an optional flip cap remover.

FIG. 6 is a schematic diagram showing the components of an automated recovery system including a flip-cap remover, conveyor belt, and reconstitution subsystem.

FIG. 7 is a detailed diagram of a reconstitution and recovery valve assembly.

### DETAILED DESCRIPTION

The systems described here are directed to methods of recovering expensive or dangerous materials from sealed containers safely, nearly completely, and with high throughput. They can be used with benign materials or with materials that are unsafe for human contact; it could be toxic, explosive, mutagenic, or carcinogenic, for example, such that human involvement in the recovery process should be kept to a minimum.

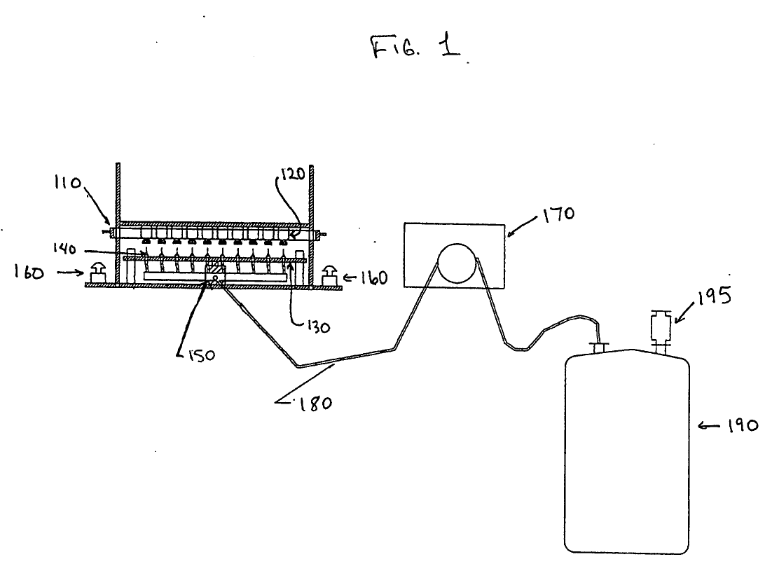

FIG. 1 is a schematic diagram showing components of an embodiment of a recovery system. The system has three main components: recovery device 100 that holds sealed vials containing a solution, a peristaltic pump 170 that pumps the solution out of the vials, and a recovery tank 190 that receives the pumped solution. In recovery device 100, vial holder cassette 110 holds solution-containing vials 120 upside down, so the solution flows to the bottom. Vials 120 can be made of any sturdy material, such as glass or plastic, which is preferably transparent so that recovery of the material can be monitored.

Caps or stoppers seal vials 120, preventing the solution from leaking during normal storage and transportation. The stoppers are made of a material that can be pierced with a needle to allow the solution to be withdrawn without removing the stopper. The stopper preferably “re-seals” after being punctured. Rubber is an example of a useful stopper material. These features of the stopper reduce the risks of human contact with a dangerous material, of further contamination, and of losing material during recovery process.

A needle holder 130 securely holds a row of needles 140 directly beneath vials 120. The needles 140 have a hollow bore, and are sufficiently strong to pierce the stoppers of vials 120 without breaking. If a needle does break it can be replaced easily by twisting it off and twisting a new one on. When a user presses two cylinder push buttons 160, an air cylinder 150 raises needle holder 130, preferably to a height where the tips of the needles 140 barely puncture the vial stoppers. This way as solution is drawn out of the vial, the tips of the needles 140 stay immersed in the solution until nearly all of the solution is withdrawn.

Tubing 180 connects each of the needles 140 to peristaltic pump 170 and then to recovery tank 190. Pump 170 is designed such that the solution does not come in contact with internal pump components, but is transmitted via continuous tubing 180 into recovery tank 190. Using such a pump allows the tubing 180 to be sterilized or discarded after the recovery process is completed, and also minimizes the risk of human exposure, contamination of the solution by the pump, contamination of the pump by the solution, and loss of the material into the pump. Recovery tank 190 has a vent filter 195 that allows gases, but not the liquid, to escape, and stores the solution until the user is ready to further process or purify it. In some embodiments, the liquid is reprocessed or purified by any needed means including by heating, filtering, disinfecting light, mixture with other materials, or any other desired process.

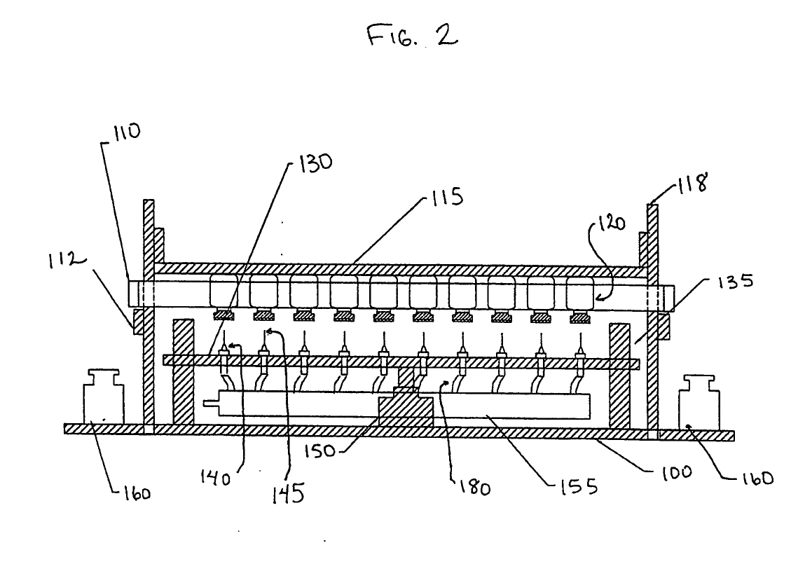

FIG. 2 illustrates in greater detail the components of recovery device 100, with the rest of the system as shown in FIG. 1. Vial holder cassette 110 holds the vials 120 stopper side down. A user locks cassette 110 into place in the device, where it is securely held in all three dimensions. Side rails 118 hold cassette 110 in place in the horizontal plane. Vial stop 115 and side rail adjustments 112 hold cassette 110 in place vertically. Vial stop 115 also prevents vials 120 from moving upwardly when the needles puncture the stoppers. Cassette 110 is easily interchangeable, allowing recovery of solution from a large number of vials in a short amount of time. While the cassette is shown with one row of 10 vials, it could be used with other plural numbers of vials in other two-dimensional arrays. The cassette can be manually provided with no system and fixed in place without a carousel or other moving device, although automated moving systems could be used. The vials can have a narrower neck and wider body, unlike a test tube, thereby creating a shoulder that can rest in the cassette.

As described previously, needle holder 130 securely mounts needles 140 to be used for solution recovery. Holder 130 approximately centers each needle tip 145 on the stopper of corresponding vial 120. The device holds needle holder 130 in place in all three dimensions. Guide rods 135 hold needle holder 130 in place in the horizontal plane. The vertical position of air cylinder 150 determines the vertical position of needle holder 130. To adjust the vertical height of 130, i.e. to controllably puncture the vial stoppers with needles 140, the user simultaneously pushes two push buttons 160. Two buttons are provided as a safety measure, in order to keep the user's hands away from the moving needles 140 and to prevent accidental starting. Other safely methods could be used, preferably including two simultaneous actions to start the process. Needle holder 130 stays raised as long as both buttons 160 are pressed, and then lowers when buttons 160 are released. When the user presses buttons 160, a valve (not shown) opens, allowing compressed air at about 100 psi to raise air cylinder 150 to a pre-set height appropriate to the size of vials 120. Once needles 140 pierce the stoppers at the appropriate height, the user activates peristaltic pump 170 with a foot switch (not shown). The needles 140 connect to manifold 155 with tubing 180, which connects to pump 170 via additional tubing 180 as illustrated in FIG. 1.

In one use, mass balances were used to monitor the yield of solution recovery, by weighing the vials before and after recovery, and it was found that the system recovered more than 95% of the material from 2 mL vials. Each cassette holds 10 vials, and by interchanging cassettes the device can be used to recover material from about 2000 vials per hour. The cassette is not limited to this size, and can be made as large or as small as needed to hold the desired size and number of vials. 2 mL is only provided as an example vial size, since it is commonly used for doses of drug solutions. Vials would not need to be used at all, but any container with a section that could be punctured without breaking or leaking could be used.

In the described system the user locks the cassettes into place and controls the needle height, but an automated system for exchanging cassettes and controlling the needle height could be implemented and would allow for even faster throughput of vials. Also, while the described recovery system moves the needles to puncture the vials, the needles could also be held fixed and the vials moved downwardly instead.

A solution is not the only material that can be recovered from sealed vials with the described system. If the vial contains a solid, or a liquid that is too viscous to pump out, the system can be used to introduce into the vial an appropriate solvent that dissolves the material. This is done by switching the recovery tank with a container of the solvent, and setting the pump to operate in reverse. The cassette holds the vials as usual, and the user presses the push buttons to raise the needles up to puncture the stoppers. Then the user activates the pump, which pumps solvent into the vials. This creates a solution suitable for recovery as usual. The user releases the pump and lowers needles, and then switches the system back to its original configuration, and operates it as described above. The switching can be automated.

The needles 140, manifold 155, tubing 180, and recovery tank 190 are the only components that come in contact with the material, and are preferably non-reactive with the material. If the system is used to recover different materials, the tubing, manifold, needles, and tank should be changed for use with each different material to avoid cross-contamination and also potential reactivity. The pump itself does not need to be peristaltic, but any pump that has the functionality of isolating the solution from contamination in the pump could be used.

The systems described here can be used with any liquid that should be recovered, including liquids that are expensive and/or potentially harmful, such as anti-cancer drugs.

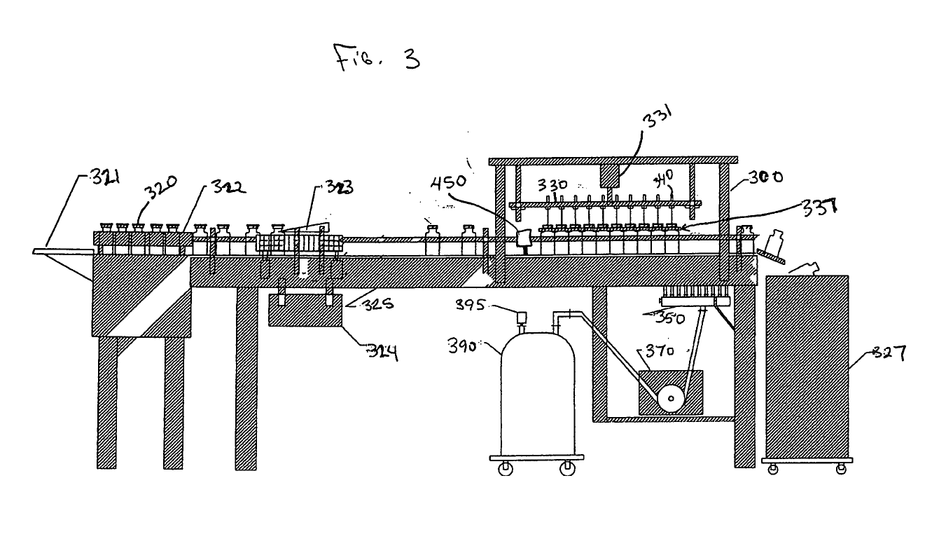

The system can also be fully or partially automated in order to enhance the ease of use of the system. FIG. 3 is a schematic diagram showing components of an embodiment of a recovery system similar to the one described above, but including additional features that automate certain aspects of the operation. Like the system illustrated in FIG. 1, the automated system of FIG. 3 includes three main components: a recovery device 300, recovery peristaltic pump 370, and recovery tank 390. In order to automate certain aspects of the system's operation, the system of FIG. 3 also includes an accumulation area 322 for holding a plurality of vials to be processed, an optional flip-cap remover 323 for removing flip-caps from vials, a vial positioner 337 that positions the vials appropriately for liquid recovery, and a conveyor belt 325 for transporting the vials through the different features of the system. The system also includes a programmable logic controller (not shown) that is in communication with various components of the system including recovery device 300, vial positioner 337, recovery peristaltic pump 370, and conveyor belt 325, and that coordinates the motion of these components so that the system automatically transports the vials through the different components of the system, and recovers liquid from the vials.

In operation, the user manually loads vials 320, e.g., from cases or boxes, into accumulation area 322. Nearby load table 321 provides a supportive surface for holding the cases or boxes while the user loads the vials 320 into the accumulation area 322. The user need not carefully arrange the vials 320 within the accumulation area, as the automated components of the system position the vials 320 throughout the system, as needed. The user initiates the system by entering an appropriate command to the logic.

Under control of the programmable logic controller, conveyor belt 325 transports the vials 320 from the accumulation area 322 to the optional flip-cap remover 323. Vials 320 optionally include flip-caps that cover and provide durable protection to the caps or stoppers during normal storage or transportation, but can be relatively easily removed by the user. The flip-caps prevent the caps or stoppers from becoming contaminated by dirt, fingerprints, or other environmental contaminants during transportation, so that when the needles puncture the caps or stoppers in order to recover the solution from the vials, those contaminants do not end up on the needle and thus taint the solution. Optional flip-cap remover 323 can be included in the system when vials having flip-caps are to be processed, so that a user need not manually remove the flip-caps from the vials.

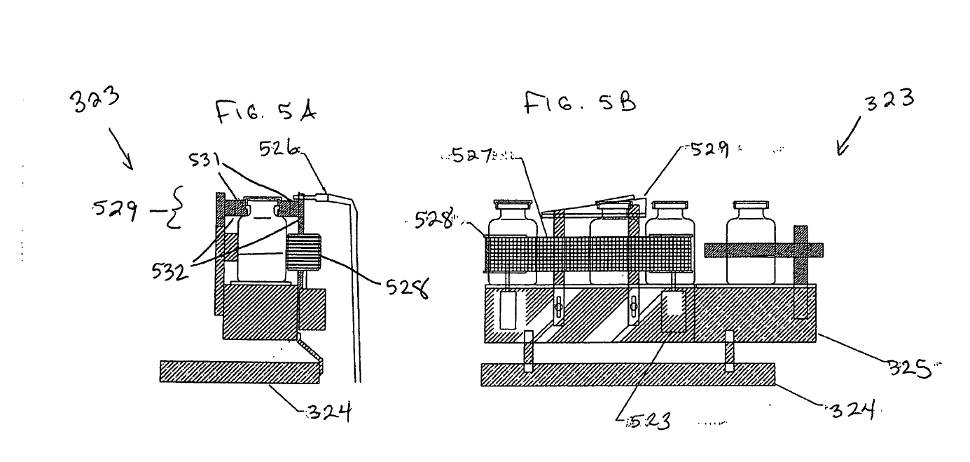

FIG. 5B shows a detailed side view of optional flip-cap remover 323. Conveyor belt 325 routes the vials 320 through flip-cap remover 323. A gripper belt 528, which is driven by a small DC fractional horse power motor 523 (or other appropriate driving device) that is in communication with and controlled by the programmable logic controller, grips and advances the vial past a set of wedge-shaped flip-cap removal tools 529 that pry the flip-cap off of the vial and into catch tray 324. The incline of the tool, as can be seen in FIG. 5B, removes the flip cap as the vial passes by. FIG. 5A shows a front view of flip-cap remover 323. As the gripper belt 528 advances the vial 320 past the flip-cap removal tools 529, the upper surfaces 531 of the tools contact the ends of the flip cap, and pry the cap off as the vial advances past the tools, while the lower surfaces 532 of the tools prevent the vial from lifting. A small, continuous compressed gas stream blows the removed flip-cap into the catch tray 324.

Referring again to FIG. 3, after optional flip-cap removal, conveyor belt 325 then transports the vials 320 to the recovery device 300 under control of the programmable logic controller. Recovery device 300 is similar to that illustrated in FIG. 2, but includes additional features that automate the recovery of solution from vials 320. Recovery device 300 includes needle holder 330, which holds a row of needles 340 relative to vials 320, and air cylinder 331, which moves the needles 340 so that they puncture the vial stoppers, as opposed to moving the vials as shown in FIG. 2 (more below). Tubing (not shown) connects the needles 340 to recovery manifold 350, recovery peristaltic pump 370, and recovery tank 390, which are substantially as described above for the system illustrated in FIGS. 1 and 2.

In order to automate recovery of solution from the vials, recovery device 300 further includes vial positioner 337 that is in communication with the programmable logic controller. As discussed in greater detail below, the programmable logic controller instructs vial positioner 337 to correctly align an appropriate number of vials relative to the row of needles 340. Then, the programmable logic controller actuates the air cylinder 331, which translates needle holder 330 downwards so that needles 340 puncture the vial stoppers, preferably to a height were the tips of needles 340 are near the bottoms of vials 320. This way as solution is drawn out of the vial, the tips of the needles 340 stay immersed until nearly all of the solution is withdrawn. After moving needle holder 330, the logic then starts recovery peristaltic pump 370, which pulls the solution out of the vials, through recovery manifold 350, through pump 370, and into recovery tank 390. Recovery tank 390 has a vent filter 395 that allows gases, but not the liquid, to escape. Once the solution is recovered from the vials, conveyor belt 325 transports the substantially empty vials for disposal in empty vial collection bin 327.

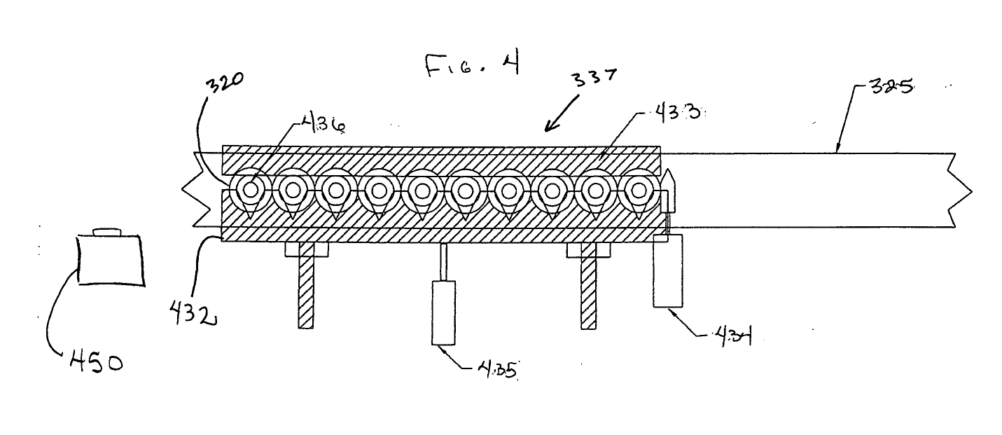

FIG. 4 shows a detailed top view of vial positioner 337 relative to conveyor belt 325. The other features of recovery device 300 are omitted for clarity, but their position relative to vial positioner 337 can be seen in FIG. 3. Vial positioner 337 includes vial counter 450, stop cylinder 434, vial locator 432, vial locator cylinder 435, and vial stop 433, and is designed to correctly position a predetermined number of vials at a time, e.g., ten vials, relative to a corresponding number of needles 340.

In order to correctly position and subsequently withdraw liquid from vials 320, the programmable logic controller first actuates stop cylinder 434 into the path of the vials, which prevents conveyor belt 325 from transporting the vials out of recovery device 300 before the device recovers solution from them. Vial counter 450, e.g., a commercially available LED-based vial counter, counts the number of vials that conveyor belt 325 transports into recovery device 300, and relays that information to the programmable logic controller. When the vial count equals the predetermined number of vials, the programmable logic controller stops conveyor belt 325 so as to not transport excess vials into recovery device 300. At this time, the predetermined number of vials is positioned loosely between vial stop 433 and vial locator 432 along conveyor belt 325.

Next, the programmable logic controller actuates vial locator cylinder 435, which positions vial locator 432 relative to vial stop 433 so as to firmly hold the vials in place between them. Vial locator 432 includes a number of grooves, each of which is sized and shaped so as to position a corresponding vial stopper center 436 beneath a corresponding needle (not shown) when cylinder 435 positions vial locator 432 relative to vial stop 433. The grooves go around the neck of the vials, which prevents the vials from lifting beyond a certain point when needles are withdrawn from them; the upward force caused by the withdrawn needles presses the shoulder of the vial against the lower surface of the vial locator. The grooves are also appropriately spaced from each other to provide a sufficient amount of space between the vials, as well as to position them correctly relative to the needles. “V” grooves are useful because they can center vials of a variety of sizes relative to the needles. For example, in some embodiments the grooves are sized to center vials between the sizes of about 5 mL and 30 mL, without needing to change the tool. In other embodiments, semicircular grooves that are sized for one particular vial size, e.g., 5 mL, can be used. The number, size, and spacing of the grooves can be selected according to the size of the vials to be processed. The vial locator 432, vial stop 433, and/or needle holder 330 can be readily removed and replaced with vial locators, vial stops, and needle holders of different sizes, spacings, and shapes, so that the system can readily recover solution from vials of many different sizes and shapes, for example between about 5 mL and 500 mL.

As discussed above, the programmable logic controller then actuates air cylinder 331 so that the needles pierce the vial stoppers to an appropriate height, and starts recovery peristaltic pump 370 to withdraw solution from the vials. The pump operates for a desired time. This time can correspond to the amount of time needed to withdraw the solution from the vials, which depends on the volume of solution in the vials as well as the rate at which recovery peristaltic pump 370 pulls solution from the vials via needles 340, tubing (not shown), and recovery manifold 350. The programmable logic controller stops peristaltic pump 370, raises air cylinder 331 to withdraw needles 340 from the vials, and actuates vial locator cylinder 435 to position vial locator 432 away from vial stop 433, so that the vials are no longer held in place. Then, the programmable logic controller actuates stop cylinder 434 out of the path of the vials and re-starts conveyor belt 325, which transports the substantially empty vials for disposal in empty vial collection bin 327. The motion of conveyor belt 325 brings a new set of vials into recovery device 300, and the programmable logic control repeats the process of recovering solution from the new vials as described above, beginning with actuating stop cylinder 434 into the path of the new vials.

Note that the vials in the system illustrated in FIG. 3 are kept cap-side up, and are not turned cap-side down as shown in FIG. 2. Although the cap-side up position potentially allows for recovery of slightly less liquid than does the cap-side down position, because a small amount of liquid may remain at the bottom of the vial, the overall throughput of the system can be improved by leaving the vials cap-side up. Specifically, while the recovery system can be modified to include an appropriate component that turns the vials cap-side down (either individually or some number at a time) before recovering solution from them, it can be faster and mechanically simpler to simply leave the vials cap-side up, with possibly a small reduction in the amount of solution ultimately recovered from the vials.

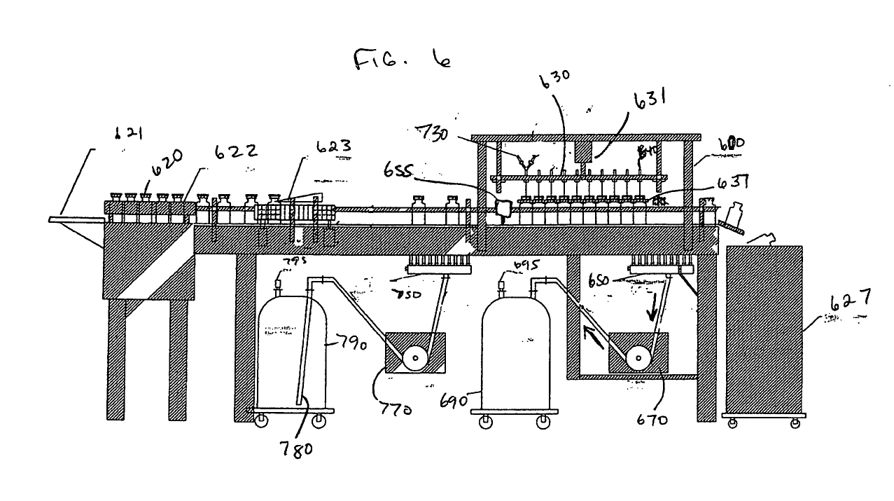

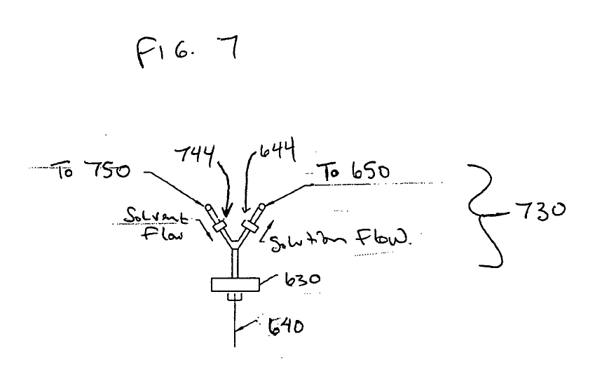

If the vials instead contain a solid or viscous liquid to be recovered, the system can be modified to introduce a solvent into the vial to dissolve the solid or viscous liquid, and subsequently recover the resulting solution. FIG. 6 is a schematic diagram showing components of an embodiment of an automated recovery system similar to that illustrated in FIG. 3, but that further includes a subsystem for introducing a solvent to the vial in order to dissolve a material that would not otherwise be easily recoverable. The recovery system of FIG. 6 includes loading area 621, accumulation area 622, conveyor belt 625, optional flip cap remover 623, vial positioner 637, needle holder 630, needles 640, air cylinder 631, recovery manifold 650, vial counter 655, recovery peristaltic pump 670, recovery tank 690, filter 695, and a programmable logic controller (not shown), which are substantially the same as those described with reference to FIG. 3. The system of FIG. 6 also includes a solvent subsystem that includes solvent tank 790 with filter 795, solvent manifold 750, and solvent peristaltic pump 770 in communication with the programmable logic controller. Referring also to FIG. 7, recovery device 600 is modified to include reconstitution and recovery Y-valve assemblies 730, each of which is associated with a needle 640 and is in communication with the programmable logic controller. Tubing (not shown) connects each of the Y-valve assemblies 730 to solvent manifold 750, solvent peristaltic pump 770, and solvent tank 790, and separately connects Y-valve assemblies 730 to recovery manifold 650, recovery peristaltic pump 670, and recovery tank 690.

FIG. 7 shows a detailed view of a Y-valve assembly 730 as connected to a portion of needle holder 630 and needle 640. Assembly 730 includes tubing that connects to solvent manifold 750 and tubing that connects to recovery manifold 650. The small arrows indicate the direction of fluid flow within the tubing (into the assembly for the solvent, and out of the assembly for the solution of solvent plus dissolved material from the vial). Between the needle 740 and the tubing connected to the manifolds, assembly 730 also includes pinch valves 744 and 644 that are in communication with the programmable logic controller and independently operable. The controller opens and closes these valves in order to keep the solvent, and its associated tubing isolated from the solution, and its associated tubing.

Referring again to FIG. 6, after the user loads the vials into accumulation area 622, the programmable logic controller transports the vials to optional flip-cap remover 623, and then to recovery device 600. At recovery device 600, the programmable logic controller instructs vial positioner 637 to correctly align vials 620 relative to needles 640, and then actuates air cylinder 631 to translate needle holder 630 downwards to an appropriate height, substantially as described above.

Referring also to FIG. 7, the programmable logic controller then pumps an appropriate volume of solvent into the vials. Specifically, the controller opens pinch valve 744, closes pinch valve 644 to keep solvent from inadvertently going up the tubing towards manifold 650, and then turns on solvent peristaltic pump 770. Pump 770 pumps solvent out of solvent tank 790 via tubing 780, into manifold 750, through the open pinch valve 744 of valve 730, and through needle 640 into vial 620. After a pre-determined time corresponding to the amount of time needed to pump the appropriate volume of the solvent into the vials, which depends on the desired volume as well as the rate at which solvent peristaltic pump 770 pumps solution into the vials via needles 640, tubing, and manifold 750, the programmable logic controller turns off the solvent peristaltic pump 770. The solvent dissolves the material in the vials, thus forming a solution capable of being recovered substantially as described above.

To recover the solution, the programmable logic controller opens pinch valve 644 and closes pinch valve 744, in order to prevent the solution from inadvertently going up the tubing towards manifold 750, and then turns on recovery peristaltic pump 670. At this point, recovery proceeds substantially as described with reference to FIG. 3. After a predetermined time corresponding to the amount of time needed to substantially withdraw the solution from the vials, the programmable logic controller stops recovery peristaltic pump 670, raises air cylinder 631 to withdraw needles 640 from the vials, and instructs vial positioner 637 to release substantially empty vials 620. Then the programmable logic controller re-starts conveyor belt 625, which transports the substantially empty vials for disposal in empty vial collection bin 627. The motion of conveyor belt 625 brings a new set of vials into recovery device 600, and the programmable logic repeats the process of pumping solvent into the new vials and subsequently recovering solution from the vials.

Note that the needle height when pumping solvent into the vials, and when pumping solution out of the vials, need not be the same. In some circumstances, it may be preferable to first lower needle holder 630 to a height where the tips of needles 640 barely puncture the vial stoppers when pumping solvent into the vials, and then to lower needle holder 640 to a height where the tips of needles 640 are substantially at the bottom of the vials when pumping the solution out of the vials. Note also that while the described embodiment uses pinch valves to control the flow of solvent and solution to and from the vials, other kinds of valves can be used, for example check valves, or other kinds of valves that can be controlled by the programmable logic controller. Pinch valves are useful because they can provide an adequate seal while the pumps turn off and on.

Although the programmable logic controller turns on and off the peristaltic pumps in order to start and stop flow to and/or from the vials, in general the flow can be controlled in other appropriate ways, for example by opening or closing a valve that is inline between the pump and the manifold.

While the controller has been described primarily as a “programmable logic controller”, it should be understood that a broad range of controllers could be used, including various combinations of hardware and software in application-specific or general purpose devices. The controller could thus include small specific purpose controllers, or appropriate programmed microprocessors, or be part of larger computer systems that control other functions as well. The controller can be in communication with various components of the systems with wired or wireless connections.

Other aspects, modifications, and embodiments are within the scope of the following claims.

What is claimed is:

1. An apparatus for recovering a solution from a plurality of stoppered vials, the apparatus comprising:
a recovery subsystem comprising:
a vial positioner capable of positioning a plurality of stoppered vials in a corresponding plurality of liquid recovery positions in response to a first positioner signal and capable of releasing the plurality of stoppered vials in response to a second positioner signal;
a needle holder holding a corresponding plurality of hollow point needles, each hollow point needle being over a corresponding vial; and
an actuator capable of translating the needle holder and the vial positioner between first and second positions relative to each other in response to corresponding first and second actuator signals, wherein in the first position the needles are spaced relative to the vial stoppers and wherein in the second position the needles puncture the vial stoppers;
a recovery pump subsystem comprising:
a recovery pump to extract a solution from the plurality of vials;
a recovery vessel to collect the solution from the plurality of vials; and
tubing connecting the plurality of needles to the recovery pump and to the recovery vessel;
a conveyor subsystem capable of transporting the plurality of vials into the recovery subsystem in response to a first conveyor signal and out of the recovery subsystem in response to a second conveyor signal; and
a controller in communication with the vial positioner, actuator, and conveyor mechanism and comprising instructions to apply the first and second positioner signals, first and second actuator signals, and first and second conveyor signals such that the conveyor subsystem transports the plurality of vials into the recovery subsystem, the recovery subsystem recovers solution from within them, and the conveyor subsystem transports the plurality of vials out of the recovery subsystem.

2. The apparatus of claim 1, wherein the controller further comprises instructions to repeatedly apply the first and second positioner signals, first and second actuator signals, and first and second conveyor signals such that the conveyor subsystem transports each plurality of multiple pluralities of vials into the recovery subsystem, the recovery subsystem recovers solution from within each plurality of said multiple pluralities of vials, and the conveyor subsystem transports each plurality of said multiple pluralities of vials out of the recovery subsystem.

3. The apparatus of claim 1, further comprising a flip-cap remover configured to remove flip-caps from the plurality of stoppered vials before the conveyor subsystem transports the vials into the recovery subsystem.

4. The apparatus of claim 3, wherein the flip-cap remover comprises a gripper belt and a wedge-shaped tool, wherein the gripper belt advances each vial of the plurality of vials past the wedge shaped tool such that the wedge shaped tool removes the flip-cap from the vial.

5. The apparatus of claim 4, wherein the flip-cap remover further comprises a gas stream to blow the removed flip-cap into an adjacent catch tray.

6. The apparatus of claim 1, wherein the vial positioner comprises a vial counter in communication with the controller and capable of counting the number of vials that the conveyor subsystem transports into vial positioner.

7. The apparatus of claim 6, wherein the vial positioner comprises a stop cylinder capable of moving into and out of the path of the vials in response to corresponding first and second stop signals, and wherein the controller is in communication with the stop cylinder and provides the first and second stop signals according to the number of vials the vial counter counts.

8. The apparatus of claim 1, wherein the vial positioner includes a vial stop and a vial locator that moves toward the vial stop in response to the first positioner signal and moves away from the vial stop in response to the second positioner signal.

9. The apparatus of claim 8, wherein the vial locator comprises a plurality of grooves, each groove sized and positioned to center a corresponding vial of the plurality of vials.

10. The apparatus of claim 1, wherein the actuator is a pneumatic cylinder.

11. The apparatus of claim 1, further comprising an accumulation area adjacent the conveyor subsystem into which a user manually loads the plurality of vials.

12. The apparatus of claim 1, wherein the conveyor subsystem comprises a conveyor belt.

13. The apparatus of claim 1, wherein the controller is in communication with the recovery pump and capable of applying first and second pump signals to respectively turn the recovery pump off and on.

14. The apparatus of claim 1, wherein the recovery pump is a peristaltic pump.

15. The apparatus of claim 1, further comprising an empty vial collection bin for collecting the plurality of vials after recovering solution from them.

16. The apparatus of claim 1, further comprising a reconstitution subsystem, the reconstitution subsystem comprising:
a reconstitution pump to pump solvent into the plurality of vials;
a reconstitution vessel to store the solvent; and
tubing connecting the plurality of needles to the reconstitution pump and to the reconstitution vessel,
wherein the controller is capable of turning off and on each of the reconstitution pump and the recovery pump and comprises instructions to turn on the reconstitution pump so as to pump solvent into the plurality of vials, to turn off the reconstitution pump, to turn on the recovery pump so as to extract solution from the plurality of vials, and to turn off the recovery pump.

17. The apparatus of claim 16, wherein the tubing comprises a plurality of reconstitution valves, each reconstitution valve between a needle and the reconstitution pump, and a plurality of recovery valves, each recovery valve between a needle and the recovery pump, wherein the controller is capable of opening and closing the plurality of reconstitution valves and the plurality of recovery valves, and wherein the controller comprises instructions to open the reconstitution valves and close the recovery valves when the reconstitution pump is on, and instructions to close the reconstitution valves and open the recovery valves when the recovery pump is on.

18. The apparatus of claim 16, wherein the solvent is selected to dissolve a material within the vials and thus form the solution to be recovered.
